(19) United States
(12) Patent Application Publication
(10) Pub. No.: US 2011/0187576 A1
(43) Pub. Date: Aug. 4, 2011

(54) JAMMER ANTENNA SYSTEM

(76) Inventor: Michael Salewski, Bad Salzdetfurth (DE)

(21) Appl. No.: 13/031,187

(22) Filed: Feb. 19, 2011

Related U.S. Application Data
(63) Continuation of application No. 12/812,414, now abandoned.

(30) Foreign Application Priority Data
Jan. 11, 2008 (EP) 08000464.1

(51) Int. Cl. G01S 7/38

(52) U.S. Cl. 342/14

(57) ABSTRACT

The invention relates to a jammer antenna system having a main plate, the main plate being substantially horizontally oriented during use of the jammer antenna system, a horizontal antenna provided in the main plate and arranged for radiating horizontally polarized radiation; first vertical antenna removably attached to the main plate; and at least one second vertical antenna removably attached to the main plate for radiating vertically polarized radiation. The invention proposes to provide a first vertical antenna, the horizontal antenna, and the second vertical antenna being electrically decoupled, such that removing one of the vertical antennas does substantially not change a horizontal antenna intrinsic impedance of the horizontal antenna or a first vertical antenna intrinsic impedance of the first vertical antenna.

This application is a continuation of U.S. patent application Ser. No. 12/812,414, filed on Jul. 9, 2010, which is a national stage application of PCT/EP 2009/000037, filed Jan. 7, 2009, which claims priority to European Patent Application 08000464.1, filed Jan. 11, 2008. The disclosure of U.S. patent application Ser. No. 12/812,414 and PCT/EP 2009/000037 are incorporated herein by reference.

### BACKGROUND AND SUMMARY OF THE DISCLOSURE

The invention relates to a jammer antenna system, comprising (a) a main plate, said main plate being substantially horizontal oriented during use of the jammer antenna system and (b) a horizontal antenna provided in the main plate and arranged for radiating horizontally polarized radiation, (c) a first vertical antenna removably attached to the main plate, and (d) at least one second vertical antenna removably attached to the main plate for radiating vertically polarized radiation.

Jammer antenna systems are parts of jammer systems that may be provided on automobiles, such as cars. These jammer systems are used to jam wireless bombs. Known jammer antenna systems are bulky and can easily be attacked and destroyed with a gun. If it is hit by bullet, the entire jammer antenna system needs to be overhauled and repaired. This is time consuming or even impossible in remote areas. Thus, jammer antenna systems known from prior art only provide a moderate reliability and maintainability under harsh conditions.

A jammer antenna system according to the preamble of claim 1 is known from U.S. Pat. No. 4,763,131. This document deals with an improved way to fix antennas to a look-periodic monopol antenna array. It is a disadvantage of a jammer antenna system known from this document that it is difficult to maintain, especially in difficult environments. If, for example the known jammer antenna system is hit by a bullet, it is difficult to replace the destroyed antenna of the antenna array. This might lead to an insufficient jamming performance of the jammer antenna system giving rise to an increase risk.

From US 2007/0063886A1 general jammer antenna systems are known. Another jammer antenna system is known from the paper “A report on Japanese Development of Antennas: From the Yagi-Uda Antenna to Self-Complementary Antennas” by Yasuto Mushiake, IEEE Antennas and Propagation Magazine, VI. 46, No. 4, August 2004. Other antenna systems are known from EP 0 709 914 A1 and DE 103 07 085 A1. These antenna systems suffer from pure maintainability under difficult security circumstances as described above.

It is an object of the present invention to provide a jammer antenna system having an increased reliability and maintainability.

The invention solves the problem with a jammer antenna system according to the preamble of claim 1, comprising a first vertical antenna removably attached to the main plate and at least one second vertical antenna also removably attached to the main plate, both for radiating vertically polarized radiation.

The vertical antennas may be plugged to the main plate. Thus, the jammer antenna system is a modular antenna system. As the vertical antennas are removable it is easily possible to separate the vertical antennas from the horizontal antenna. As the horizontal antenna is usually flat and difficult to attack with a gun from the same ground level, it is unlikely that the vertical antenna can be destroyed. In contrast, the vertical antennas are more easily hit by bullets. However, they can be replaced easily and quickly by removing the destroyed vertical antenna and replacing it.

It is a further advantage of the jammer antenna system according to the invention, that it is easy to upgrade the jammer antenna system to a different frequency band. The frequency bands used for technical applications and that may be used also by terrorists change by time. The jammer antenna system according to invention can be upgraded simply by adding another vertical antenna to an existing vertical antenna port of the main plate or by replacing an existing vertical antenna with an upgraded one. In other words, the jammer antenna system according to the invention is much more flexible as jammer antenna systems known from prior art.

It is yet another advantage that a jammer antenna system according to the present invention can be constructed in a less bulky way than prior art systems. As usually jammer systems are used to protect convoys for example for high profile politicians, those persons are to not intended to see a bulky jammer antenna system and may otherwise feel less secure and less comfortable.

In a preferred embodiment, the jammer antenna system comprises four, five, six, seven or more vertical antenna ports for receiving vertical antennas. The ports can comprise (male) plugs and/or (female) sockets. It is also possible and preferred that the jammer antenna system comprises more than one horizontal antenna.

According to the invention the horizontal antenna and/or the first vertical antenna and the second vertical antenna are electrically decoupled and such that removing the second vertical antenna does substantially not change a horizontal antenna intrinsic impedance of the horizontal antenna or a first vertical antenna intrinsic impedance of the first vertical antenna. It is then possible to remove one of the vertical antennas from its port and to replace it by another vertical antenna without altering the antenna properties of the remaining antennas. Changing or replacing a vertical or horizontal antenna is easy and can be performed rapidly. The feature that the intrinsic impedance is substantially not changed means that it is possible, but not necessary that the intrinsic impedance does not change. Small changes below a given threshold, e.g. 1/1000, are tolerable. When referred to it is preferred that each vertical antenna is adapted for radiating waves of a predetermined frequency band, the predetermined frequency bands being pairwise disjunct. This effectively suppresses interferences between two antennas.

To protect a convoy, it is usually sufficient to cover a limited area, e.g. in front of the jammer antenna system or behind the jammer antenna system with respect to a driving direction of a car on which the jammer antenna system is mounted. Therefore, it is preferred that at least one vertical antenna and/or horizontal antenna has an antenna gain.

Preferably, the main plate consists of several printed circuit boards, e.g. a stack of printed circuit boards. The main plate may also be a multi layer printed circuit board. The printed circuit boards may also comprise etched coupling coils or jiggers or capacitive elements. Preferably, all electric components of the jammer antenna system are made by etching. At least one of the antennas is preferably a printed multi-layer circuit board Yagi antenna, a printed multi-layer circuit board logarithmic periodic (LogPed) antenna, or a printed multi-layer circuit board rod antenna. That is, the respective antenna is produced by etching a metal layer from a metal clad circuit board.

In a preferred embodiment, at least one of the antennas comprises a gold conductor on a circuit board as its dipole element. Usually, gold is not used for producing antennas because of its high price. However, it has turned out that gold dipole elements lead to especially flat jammer antenna systems and withstand high temperatures. It is preferred that at least one antenna is adapted for a continuous transmitting power of more than 100 W.

Normally, high frequency components interact, so that a high frequency intrinsic impedance of one electrical component is influenced by the high frequency electrical intrinsic impedance of another electrical component. It is, however, preferred that changing one vertical antenna does not alter the electrical properties, especially the high frequency intrinsic impedance of the remaining horizontal and vertical antennas. It has turned out that this objective can be achieved by providing at least one electrical connective for connecting the jammer antenna systems to a jammer sender unit, said electrical connector e.g. being located at a bottom side of the jammer system, wherein the main plate comprises a first layer circuit board having a horizontal antenna; a second layer circuit board arranged parallel to the first layer circuit board; one of the circuit boards having a first connecting conductor for connecting the electrical connector to the first vertical antenna.

To cover a bigger range of frequencies, the main plate may comprise a plurality of n-th layer circuit boards, the n-th layer circuit boards having connecting conductors connecting the electrical connector a dedicated vertical or horizontal antenna, wherein each vertical projection of the connecting conductors on a neighboring layer circuit board has no overlap with another connection conductor. For example, if n equals three, the main plate comprises a third layer circuit board, and so on.

It is possible to provide the horizontal antenna dipole element in an interior portion of the horizontal antenna circuit board, wherein the first connecting conductor is located horizontally outside the interior portion.

To minimize interaction between the antennas and/or the connecting conductors, in a preferred embodiment the connecting conductors are shielded. That is, between two connection conductors, an electrical shielding area is located or each connecting conductor is surrounded by a shielding. This shielding may be etched.

More generally, the main plate may comprise a third vertical antenna circuit board, a forth vertical antenna circuit board, and so on. Reconnecting conductors are arranged so that the vertical projection of the connecting conductors of a given vertical antenna circuit board on a neighboring vertical antenna circuit board does not have an overlap with the connecting conductor of the latter vertical antenna circuit board. It has turned out that interferences between two electrical conductors mainly occur in areas, where the electrical conductors are close to each other. The least possible distance between two connecting conductors equals to the distance between the respective circuit boards. Providing non-overlapping electrical conductors thus yields less interferences.

It is preferred to provide at least one of the second, third, or higher layer circuit board with at least one horizontal antenna. This yields a compact jammer antenna system.

To change the height of the jammer antenna system with the respect to ground, the jammer antenna system preferably has an antenna holder for mounting the antenna system to a vehicle roof. The antenna holder may be mounted close to a center of gravity of the jammer antenna system and may comprise a lifting device for changing a working distance between the main plate of the jammer antenna system and the vehicle roof. The antenna holder may be arranged to have a working distance being adjustable to at least one meter. It is preferred that the antenna holder also is arranged for tilting the main plate, e.g. up to 90°. The antenna holder may be provided with a rod antenna or spiral antenna for radiating low radio frequency waves in a range of e.g. 20 MHz to 140 MHz.

In a preferred embodiment, the main plate comprises at least one intermediate circuit board having electrical components that are no part of an electrical circuit, e.g. shielding elements. It is possible to provide intermediate circuit boards and/or shielding elements between each pair of two horizontal antennas.

To provide an even more flexible jammer antenna system, the vertical antennas may comprise ports for receiving further horizontal and/or vertical antennas. Those further horizontal and/or vertical antennas are removably connected to the electrical connector of the jammer antenna system by a shielded connecting conductor provided in the respective vertical antenna to which it is mounted.

The jamming antenna system may also comprise active compounds and connecting conductors for contacting those active compounds to a power source connecting plug. It is preferred that the active compounds are also etched, e.g. from a gold layer of a printed circuit board precursor.

For optical jamming, the jammer antenna system preferably comprises a plurality of LEDs having a cone of illumination that is directed downwards. The LEDs are each connected to a connecting conductor, so that each LED may be powered independently from the other LEDs. The LEDs may cover a wide spectral range from IR radiation to near UV radiation. The LEDs are connected to the main plate via a plug-and-socket connection. It is also possible to provide light detecting means for detecting incoming light signals. The LEDs have one common connector for connecting to a jammer sender unit or power supply.

The scope of the present invention also extends to a jamming system, comprising a transmitting jammer antenna system as described above and a jammer sender unit electrically connected to the jammer antenna system.

If the jammer antenna system is mounted on a vehicle, the vertical antennas are arranged so that their longitudinal axes align with a longitudinal axis of the vehicle, thus leading to a small area exposed to the relative wind during travel.

### BRIEF DESCRIPTION OF THE DRAWINGS

An example of an embodiment of the present invention is shown in the following drawings, in which:

FIG. 1 is a perspective view of a jammer antenna system according to the present invention;

FIG. 2 is a top view on a first layer circuit board of a main plate of the antenna system of FIG. 1;

FIG. 3 is a top view on a second layer circuit board;

FIG. 4 is a top view on a third layer circuit board of a main plate of a jammer antenna system according to FIG. 1;

FIG. 5 depicts a top view on a fourth layer circuit board;

FIG. 6 depicts a top view on a fifth layer circuit board;

FIG. 7 is a schematic view of vertical projections of all connecting conductors and antennas on the first vertical antenna circuit board;

FIG. 8 is a cut side view on the jammer antenna system with a first vertical antenna; and

FIG. 9 shows a jammer antenna system according to a second embodiment, the jammer antenna system comprising a reflector element.

### DETAILED DESCRIPTION OF THE DRAWINGS

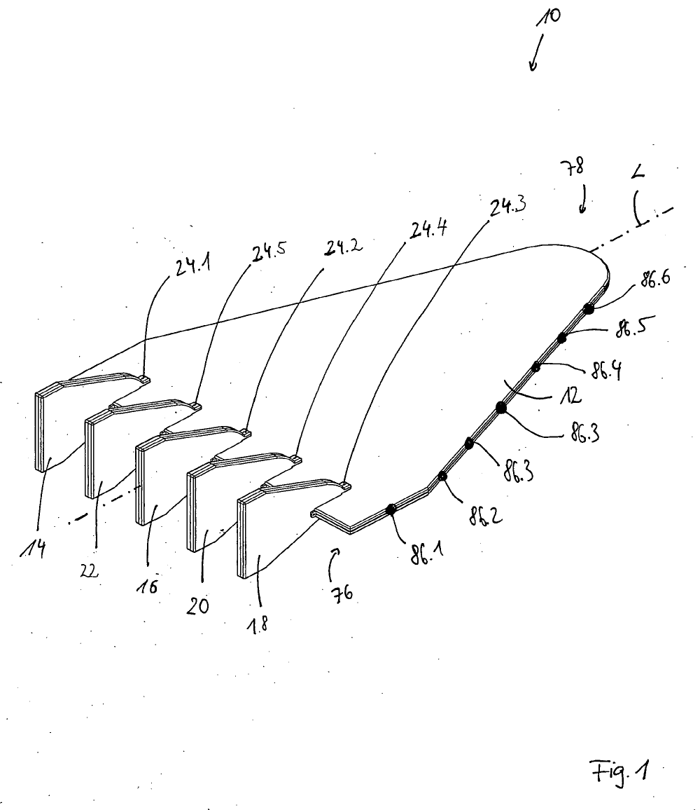

FIG. 1 depicts a jammer antenna system 10 comprising a main plate 12, a first vertical antenna 14, a second vertical antenna 16, a third vertical antenna 18, a forth vertical antenna 20, and a fifth vertical antenna 22. All vertical antennas 14 to 22 are removably attached to the main plate 12 by a plug-and socket connection and are fastened by respective screws 24.1, 24.2, 24.3, 24.4, 24.5. The vertical antennas 14 to 22 have substantially the same shape and are located equidistantially at a broadside of triangle shaped main plate 12.

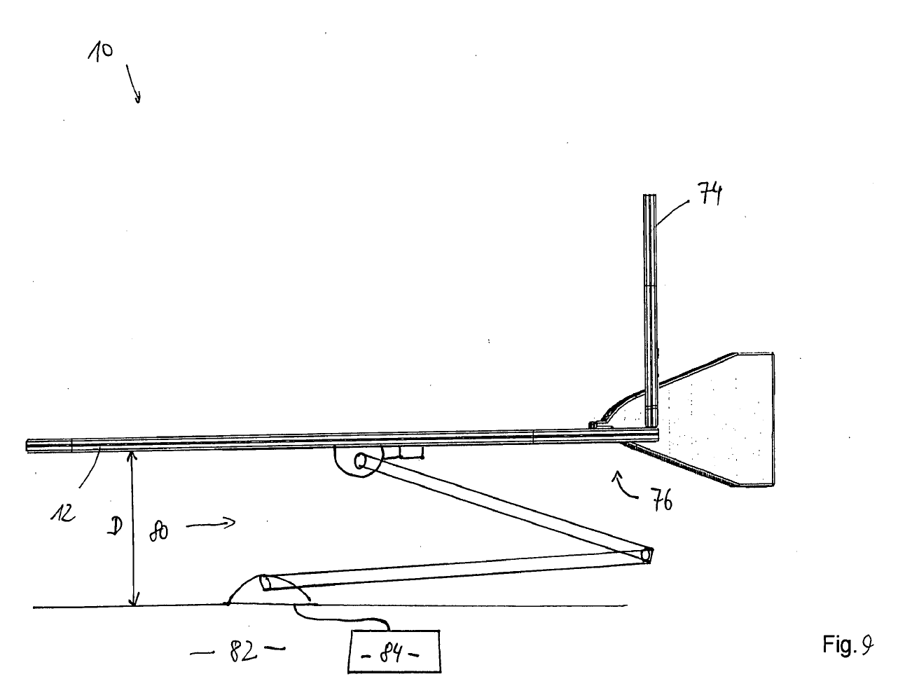

Jammer antenna system 10 comprises an antenna holder (see FIG. 9) for mounting the jammer antenna system 10 to a vehicle roof. In FIG. 1, the vehicle roof would be below main plate 12. In use, main plate 12 is substantially horizontally oriented.

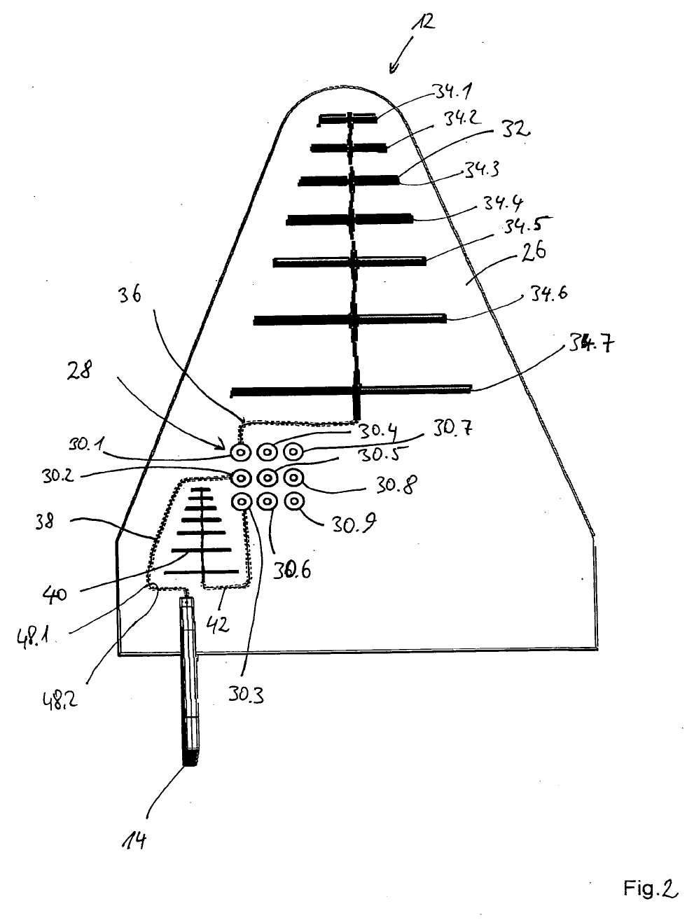

Referring now to FIG. 2, main plate 12 comprises a first layer circuit board 26 comprising an electrical connector or connector port 28 having nine female electrical contacts 30.1 to 30.9. First layer circuit board 26 comprises a first horizontal antenna 32 having dipole elements 34.1 to 34.7. Dipole elements 34.1 to 34.7 are manufactured by etching from a gold clad first layer circuit board precursor. First horizontal antenna 32 is connected to electrical contact 30.1 by a first horizontal connecting conductor 36 provided on the first layer circuit board 26. First horizontal antenna connecting conductor 36 is shielded, which is shown by two dashed lines. Connector port 28 is a female part of an electrical connector for connecting the jammer antenna system 10 to a jammer sender unit powering the jammer antenna system.

First vertical antenna 14 is connected to electrical contact 30.2 via a shielded first vertical antenna connecting conductor 38. A second horizontal antenna 40 is connected by a second horizontal antenna connecting conductor 42 to electrical contact 30.3.

First horizontal antenna 32 is a logarithmic periodic antenna and is adapted for radiating horizontally polarized radiation with a frequency between 137 MHz for dipole element 34.7 and 470 MHz for dipole element 34.1. Third horizontal antenna 52 is adapted for radiating horizontally polarized radiation with a frequency between 300 MHz and 870 MHz. Fourth horizontal antenna 58 is adapted for radiating horizontally polarized radiation with a frequency between 960 MHz and 1805 MHz. Second horizontal antenna 40 is adapted for radiating waves with a frequency of 1900 MHz to 2700 MHz. First vertical antenna 14 may be adapted for radiating vertically polarized radiation with a frequency between 1805 MHz and 1990 MHz. Second vertical antenna 16 may be adapted for radiating vertically polarized radiation with a frequency between 2110 MHz and 2170 MHz. Third vertical antenna 18 may be adapted for radiating vertically polarized radiation with a frequency between 2400 MHz and 2480 MHz.

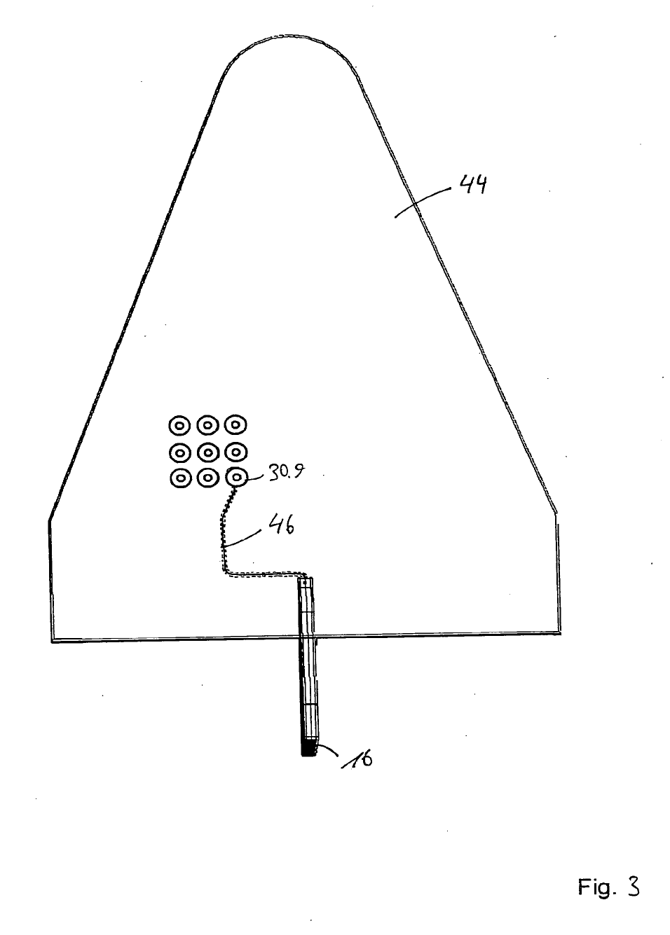

FIG. 3 shows a second layer circuit board 44 having a second vertical antenna connecting conductor 46 connecting electrical contact 30.9 to the second vertical antenna 16.

Between first layer circuit board 26 (see FIG. 2) and second layer circuit board 44 (see FIG. 3) an intermediate layer circuit board is provided abutting both, first layer circuit board 26 and second layer circuit board 44. In the intermediate layer circuit board, a shielding for first antenna horizontal connecting conductor 36, first vertical antenna connecting conductor 38 and second horizontal antenna connecting conductor 42 is provided. That is, in the intermediate layer circuit board a shielding metal layer is provided that forms a shielding together with respective left hand side and right hand side metallizations 48.1, 48.2 as shown as an example for first vertical antenna connecting conductor 38 (FIG. 2).

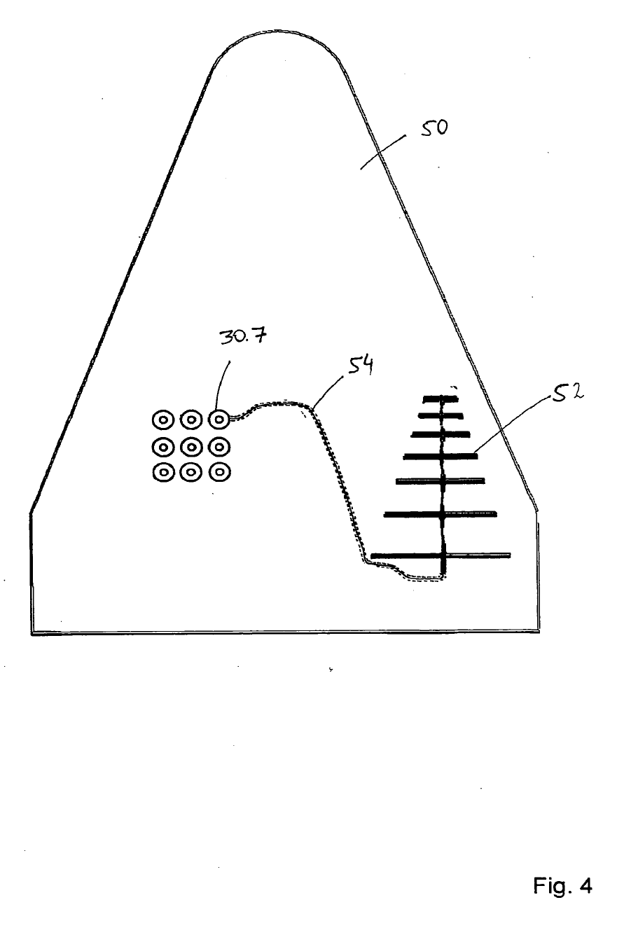

FIG. 4 shows a third layer circuit board 50 comprising a third horizontal antenna 52 in form of an etched gold layer having more than 100 μm. At least one antenna may even have a layer thickness of more than 1000 μm for small frequency band antennas. Third horizontal antenna 52 is connected to electrical contact 30.7 via a third horizontal antenna connecting conductor 54. Between third layer circuit board 50 and second layer circuit board 44, a second intermediate layer circuit board is arranged for providing parts of the shielding for second vertical antenna connecting conductor 46 (see FIG. 3) and third horizontal antenna connecting conductor 54 (FIG. 4).

Second intermediate layer circuit board may also comprise a metallization that may be connected to earth and which acts as a shielding to minimize interaction between the horizontal antennas 52 and 32 (see FIG. 2).

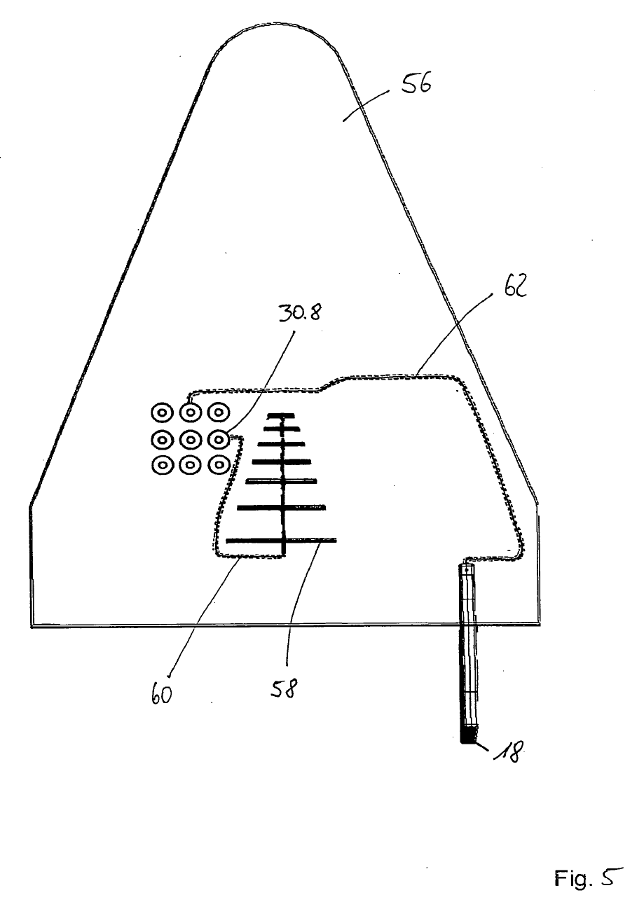

FIG. 5 shows a fourth layer circuit board 56 comprising a fourth horizontal antenna 58 connected by a fourth horizontal antenna connecting conductor 60 to electrical contact 30.8. Fourth layer circuit board 56 also comprises a third connecting conductor 62 connected to electrical contact 30.4 for connecting third vertical antenna 18.

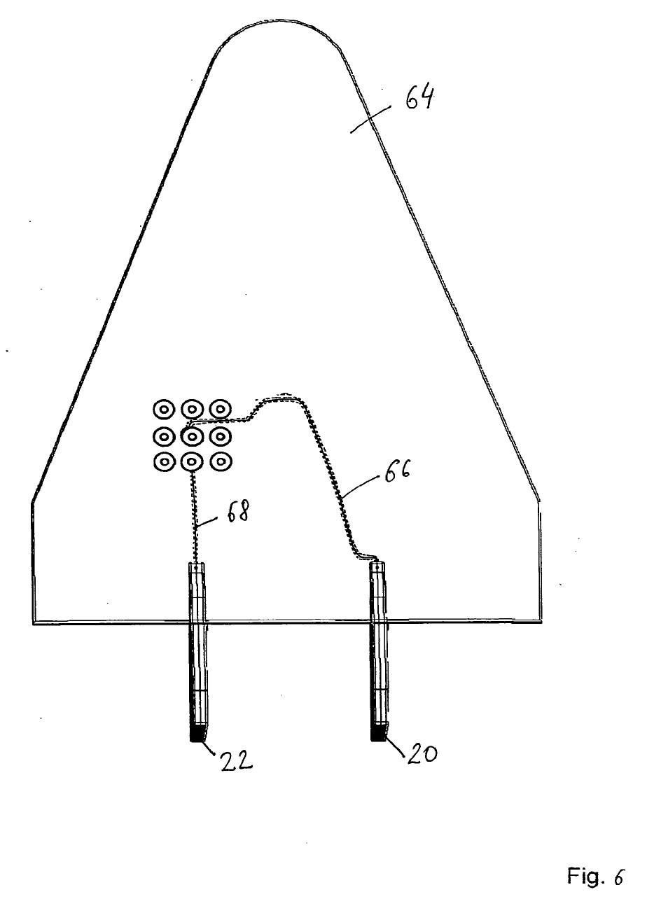

FIG. 6 shows a fifth layer circuit board 64 having a fourth vertical antenna connecting conductor 66 for connecting fourth vertical antenna 20 to electrical contact 30.5 and a fifth vertical antenna connector conductor 68 for connecting fifth vertical antenna 22 to electrical contact 30.6.

Between fourth layer circuit board and fifth layer circuit board, a third intermediate layer circuit board is provided comprising parts of the shielding for fourth vertical antenna connecting conductor 66 and fifth vertical antenna connecting conductor 68.

As can be seen from the foregoing description, all electrical connections between components of the jammer antenna system are etched electrical conductors provided on a respective printed circuit board. This leads to a flat main plate 12 (see FIG. 1) and yields a high shock resistance and vibrational resistance of the jammer antenna system 10.

The vertical antennas 14 to 22 are mechanically connected to main plate 12 via screws 24.1 to 24.5 (FIG. 1), while they are electrically connected via respective vertical antenna ports comprising a male plug and female plug. The vertical antennas 14 to 22 can be mounted to main plate 12 simply by plugging them to main plate 12, thus connecting them electrically, and by tightening the screws 24.1 to 24.5.

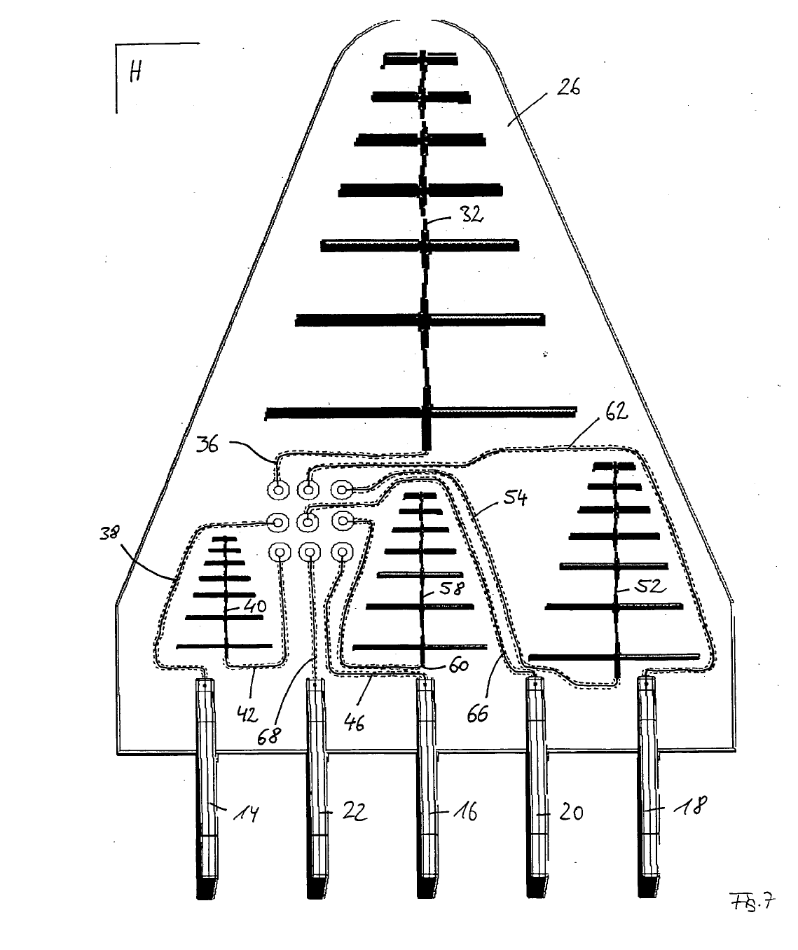

FIG. 7 is a schematic view of the vertical projections of all electrical components described above on a horizontal plane H that is parallel to first layer circuit board 26. It can be seen that the connecting conductors 36, 38, 42, 62, 66, 68, 54, 60, and 46 connected to electrical contacts 30.1 to 30.9, respectively, have no overlap with one another. Further, horizontal antennas 32, 40, 52, and 58 also have no overlap with one another. This yields a separation of all electrical components from each other so that they do not interfere in use.

Each electrical component has a specific high frequency intrinsic impedance Z which relates to a working frequency f of the respective antenna. Z has an index relating to the respective object. For example, first vertical antenna connecting 10 conductor 38 has a high frequency intrinsic impedance Z₃₈ which relates to a working frequency f₁₄ of vertical antenna 14. The other electrical components of the jammer antenna system are arranged, such that removing e.g. fifth vertical antenna 22 changes the high frequency intrinsic impedance Z₃₈ of first vertical antenna connecting conductor 38 by an amount, which is smaller than given tolerated high frequency intrinsic impedance shift AZ. To achieve this, a try and error approach may be chosen. That is, several setups are manufactured and the maximum high frequency intrinsic impedance shift ΔZ is measured for each electrical component. If for a given layout the high frequency intrinsic impedance shift ΔZ is too high, the respective electrical component is moved away from other electrical components and/or a stronger shielding is provided.

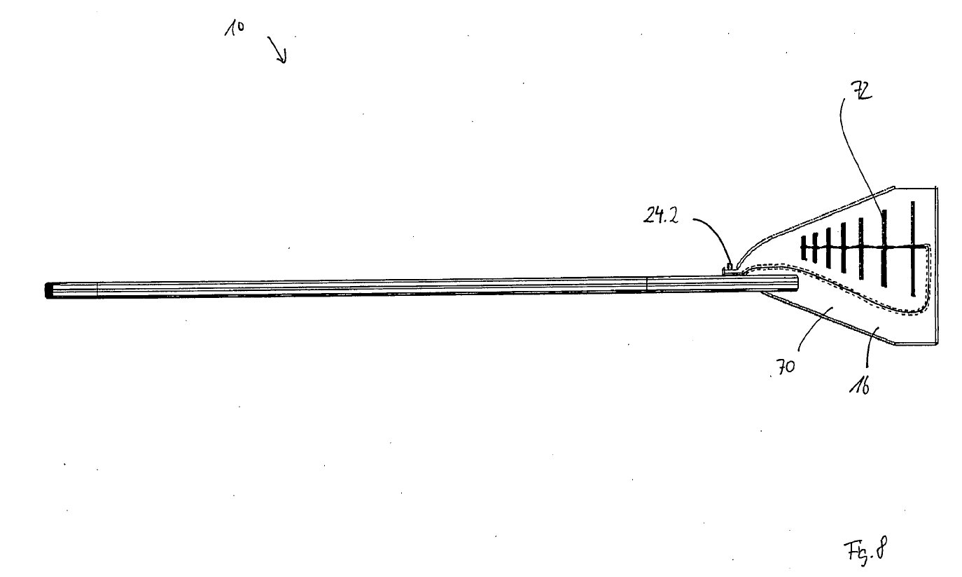

FIG. 8 shows a cut side view of a jammer antenna system 10 along a longitudinal axis L (see FIG. 1), which runs through second vertical antenna 16. Vertical antenna 16 comprises three printed circuit boards, from which the middle printed circuit board 70 is shown. Middle printed circuit board 70 comprises a vertical antenna element 72 made from an etched gold layer having a layer thickness of at least 100 μm.

FIG. 9 depicts a side view of the jammer antenna system 10 having a reflector 74 arranged at a back side 76 opposite to a tip 78 (FIG. 1) of the substantially triangle-shaped main plate 12. Reflector 74 bundles electromagnetic waves from the antennas of main plate 12 and thus increases the antenna gain.

FIG. 9 also schematically depicts an antenna holder 80 for mounting the jammer antenna system 10 to a vehicle roof 82. Antenna holder 80 also comprises a male plug having nine pins cooperating with electrical contacts 30.1-30.9 for contacting the jammer antenna system 10 to a jammer sender unit 84 in the vehicle.

Referring back to FIG. 1, main plate 12 comprises several LEDs 86.1, . . . 86.6. The LEDs are connected via antenna holder 80 through an additional electrical contact that is not shown in FIG. 1 and have a cone of light that is directed downwards for jamming LED-based remote igniting bombs.

What is claimed is:

1. Jammer antenna system, comprising;
a main plate, the main plate being substantially horizontally oriented during use of the jammer antenna system;
a horizontal antenna provided in the main plate and arranged for radiating horizontally polarized radiation;
a first vertical antenna removably attached to the main plate; and
at least one second vertical antenna removably attached to the main plate for radiating vertically polarized radiation, the first vertical antenna, the horizontal antenna, and the second vertical antenna being electrically decoupled, such that removing one of the vertical antennas does not substantially change a horizontal antenna intrinsic impedance of the horizontal antenna or a first vertical antenna intrinsic impedance of the first vertical antenna.

2. Jammer antenna system according to claim 1, characterized in that at least one of the antennas is a printed multi layer circuit board Yagi antenna, a printed multi layer circuit board logarithmic periodic antenna, or a printed multi layer circuit board rod antenna.

3. Jammer antenna system according to claim 1,
characterized in that at least one of the antennas is made of a gold layer on a circuit board.

4. Jammer antenna system according to claim 1, further comprising at least one electrical connector for connecting the jammer antenna system to a jammer sender unit; and the main plate comprising
a first layer circuit board comprising the horizontal antenna; and
a second layer circuit board arranged parallel to the first layer circuit board;
the first layer circuit board or the second layer circuit board having a first vertical antenna connecting conductor connecting the electrical connector to the first vertical antenna.

5. Jammer antenna system according to claim 4, the main plate further comprising a third layer circuit board arranged parallel to the first layer circuit board;
the first layer circuit board, second layer circuit board, or third layer circuit board having a second vertical antenna connecting conductor connecting the electrical connector to the second vertical antenna, wherein the second vertical antenna connecting conductor is located in another circuit board than the first vertical antenna connecting conductor.

6. Jammer antenna system according to claim 4, the connecting conductors being shielded; and two of the layer circuit boards being separated by a shielding layer circuit board.

7. Jammer antenna system according to claim 4, a vertical projection of the second vertical antenna connecting conductor on the second layer circuit board having no overlap with the first vertical antenna connecting conductor.

8. Jammer antenna system according to claim 4, the main plate comprising a plurality of n-th layer circuit boards, the n-th layer circuit boards having connecting conductors connecting the electrical connector to a respective vertical antenna or horizontal antenna, each vertical projection of the connecting conductors on a neighboring layer circuit board having no overlap with another connection conductor.

9. Jammer antenna system according to claim 1, comprising a plurality of LEDs, in particular having a downwards directed cone of light.

10. Jammer antenna system according to claim 1, the vertical antennas being connected to the main plate by a plug-and-socket connection and/or a click connection.

11. Jamming system comprising
a jammer antenna system according to claim 1; and
a jammer sender unit electrically connected to the jammer antenna system, so that the jammer antenna system acts as a transmitting antenna system.

12. Jammer antenna system according to claim 5, the connecting conductors being shielded; and two of the layer circuit boards being separated by a shielding layer circuit board.

13. Jammer antenna system according to claim 5, the main plate comprising a plurality of n-th layer circuit boards, the n-th layer circuit boards having connecting conductors connecting the electrical connector to a respective vertical antenna or horizontal antenna, each vertical projection of the connecting conductors on a neighboring layer circuit board having no overlap with another connection conductor.

14. Jammer antenna system according to claim 13, the connecting conductors being shielded; and two of the layer circuit boards being separated by a shielding layer circuit board.
